(19) United States
(12) Patent Application Publication
(10) Pub. No.: US 2026/0146187 A1
(43) Pub. Date: May 28, 2026

(54) EPOXY ADHESIVE COMPOSITION AND EPOXY ADHESIVE STRUCTURE

(71) Applicants: Hyundai Motor Company, Seoul (KR); Kia Corporation, Seoul (KR)

(72) Inventors: Sung Chul Shin, Hwaseong-si (KR); Jae Cheol Jeon, Hwaseong-si (KR)

(21) Appl. No.: 19/062,576

(22) Filed: Feb. 25, 2025

(30) Foreign Application Priority Data
Nov. 25, 2024 (KR) 10-2024-0169727

(51) Int. Cl. C09J 163/10; C09J 11/04; C09J 11/06

(52) U.S. Cl. CPC C09J 163/10; C09J 11/04; C09J 11/06

(57) ABSTRACT

In an embodiment an epoxy adhesive composition is disclosed. The epoxy adhesive composition includes a bisphenol-based epoxy resin, a rubber-modified epoxy resin, a hardener, a flow regulator, and a storage stabilizer, wherein the epoxy adhesive composition includes 41 wt % to 49 wt % of the rubber-modified epoxy resin, 11 wt % to 20 wt % of the flow regulator, and 0.5 wt % to 1.4 wt % of the storage stabilizer based on a total of 100 wt % of the composition.

### CROSS-REFERENCE TO RELATED APPLICATIONS

This application claims, under 35 U.S.C. § 119 (a), the benefit of priority from Korean Patent Application No. 10-2024-0169727, filed on Nov. 25, 2024, the entire contents of which are incorporated herein by reference.

### TECHNICAL FIELD

The present disclosure relates to an epoxy adhesive composition and an epoxy adhesive structure.

### BACKGROUND

Epoxy adhesives are available in types of one-component or two-component with a separate hardener, and bisphenol-based epoxy resin.

These epoxy adhesives are also used for automotive structures, but when a water washing process is performed, after application of the adhesive, as shown in FIGS. 1A and 1B, some of the exposed coating may become displaced or deformed, reducing adhesion and contaminating other portions. If the amount of the epoxy adhesive that is applied is reduced to minimize exposure to the water washing process or the epoxy adhesive is not exposed to the water washing process, stiffness and watertightness of the coating may be insufficient.

As the viscosity of the epoxy adhesive increases, water washing resistance thereof improves, but dischargeability thereof from devices such as dispensers decreases. There is a need for research into novel epoxy adhesives and compositions having such water washing resistance, workability, and good adhesion.

### SUMMARY

Embodiments of the present disclosure provide an epoxy adhesive composition having excellent dischargeability, water washing resistance, and storage stability.

Further embodiments of the present disclosure provide an epoxy adhesive composition having excellent shear bonding strength even in environments having high humidity, high temperature, etc.

Embodiments of the present disclosure are not limited to the foregoing. An embodiment of the present disclosure provides an epoxy adhesive composition, including a bisphenol-based epoxy resin, a rubber-modified epoxy resin, a hardener, a flow regulator, and a storage stabilizer, in which the epoxy adhesive composition may include 41 wt % to 49 wt % of the rubber-modified epoxy resin, 11 wt % to 20 wt % of the flow regulator, and 0.5 wt % to 1.4 wt % of the storage stabilizer, based on a total of 100 wt % of the composition.

Another embodiment of the present disclosure provides an epoxy adhesive structure, including a first member, a second member, and an adhesive interposed between the first member and the second member, in which the adhesive is obtained by curing the epoxy adhesive composition described above.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1A and 1B show contaminations of portions of a vehicle due to displacement of a conventional epoxy resin coating;

FIGS. 2A and 2B show measurement results of water washing resistance after application of a conventional epoxy resin (FIG. 2A) and a composition of an epoxy resin according to a first embodiment (Example 1, FIG. 2B);

FIG. 3 schematically shows conditions for measuring water washing resistance;

FIG. 4 is photographs showing results of measurement of water washing resistance after application of a composition of each of a conventional epoxy resin and another example (developed product) in one process; and

FIG. 5 is photographs showing results of measurement of water washing resistance after application of a composition of each of a conventional epoxy resin and another example (developed product) in another process.

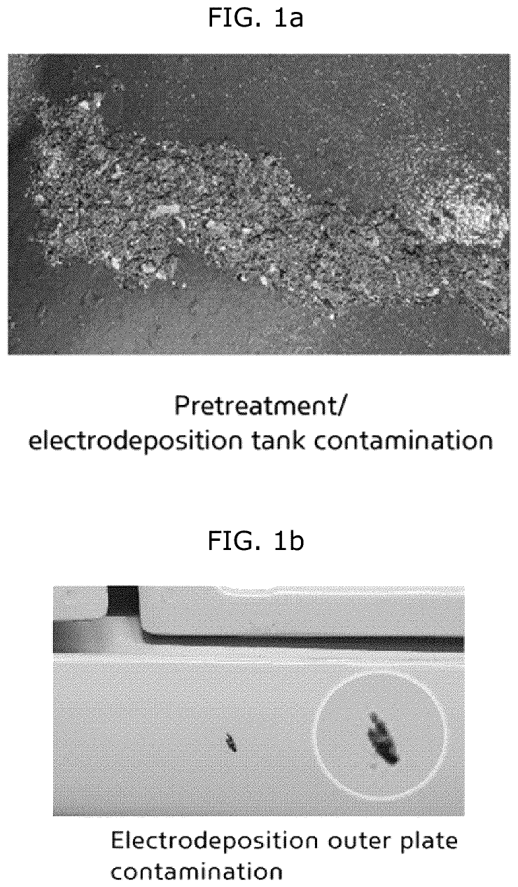

### DETAILED DESCRIPTION OF ILLUSTRATIVE EMBODIMENTS

The above and other objects, features and advantages of the present disclosure will be more clearly understood from the following embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

### Epoxy Adhesive Composition

An epoxy adhesive composition according to an embodiment of the present disclosure includes a bisphenol-based epoxy resin, a rubber-modified epoxy resin, a hardener, a flow regulator, and a storage stabilizer. The epoxy adhesive composition includes, based on a total of 100 wt % thereof, 41 wt % to 49 wt % of the rubber-modified epoxy resin, 11 wt % to 20 wt % of the flow regulator, and 0.5 wt % to 1.4 wt % of the storage stabilizer.

The bisphenol-based epoxy resin may have a viscosity at a temperature of 23° C. of 1,500,000 cP or less and 100,000 cP or more, and may have a relative viscosity lower than that of the rubber-modified epoxy resin.

The bisphenol-based epoxy resin may be related to overall shear bonding strength. The bisphenol-based epoxy resin may be selected from the group consisting of bisphenol A epoxy resin, bisphenol M epoxy resin, bisphenol F epoxy resin, bisphenol S epoxy resin, and combinations thereof, and an example thereof may include bisphenol A epoxy resin.

The rubber-modified epoxy resin may have an improved viscosity as well as improved shear bonding strength. The rubber-modified epoxy resin may be obtained by physically mixing (blending) a rubber component and an epoxy resin component, and may correspond to a physical modification or may also include a chemical modification.

The rubber-modified epoxy resin may also be manufactured by the following method, including:
(a) adding rubber particles to an acrylic resin coating agent and performing stirring,
(b) curing the stirred result,
(c) controlling the particle size of the cured result, and
(d) mixing the result having a controlled particle size with an epoxy resin.

The rubber particles in step (a) may include a rubber selected from the group consisting of butadiene rubber, acrylonitrile-butadiene rubber, styrene-butadiene rubber, and combinations thereof, and an example thereof may include butadiene rubber.

The acrylic resin coating agent in step (a) may include 20 wt % to 50 wt % of an acrylic resin and 50 wt % to 80 wt % of a solvent (or dispersion medium). If the amount of the solvent exceeds 80 wt %, the coating process may not proceed completely, whereas if the amount of the solvent is less than 50 wt %, the acrylic resin may not be dispersed well, causing a clumping phenomenon, resulting in an uneven coating thickness.

The solvent of the acrylic resin coating agent in step (a) may be a C1-C10 alcohol compound containing an ether group, and examples thereof may include 2-butoxyethanol (trade name: Butyl CELLOSOLVE), 2-propoxyethanol, 2-ethoxyethanol, 2-methoxyethanol, and the like.

The stirring in step (a) may be performed for 1 to 2 hours. If the stirring time is less than 1 hour, there may occur a large amount of a portion that is not coated with rubber particles, which may deteriorate mechanical strength of the epoxy adhesive composition, whereas if the stirring time exceeds 2 hours, unnecessary waste of resources and energy may occur.

The curing in step (b) may be performed at a temperature of 130° C. to 140° C. for 15 to 30 minutes. If the curing temperature and time are less than the above lower limits, hardness may be low due to the uncured portion, making it difficult to proceed with the subsequent step, whereas if the curing temperature and time are greater than the above upper limits, there is a concern that elasticity of the rubber particles may decrease or may be eliminated.

The coated rubber particles may be obtained through step (b).

Controlling the particle size in step (c) may be performed using typical processing means, for example, a ball mill. As such, the size of the coated rubber particles may be adjusted to 120 μm or less and 10 μm or more. If the size of the coated rubber particles exceeds 120 μm, uniform dispersion or blending in the epoxy resin may become difficult.

Step (d) may be performed such that 60 wt % to 70 wt % of the coated rubber particles obtained in step (c) are mixed with the remainder of the epoxy resin based on the total weight of the rubber-modified epoxy resin. If the amount of the coated rubber particles is less than 60 wt %, an improvement in viscosity of the epoxy adhesive composition may not be high, whereas if the amount of the coated rubber particles exceeds 70 wt %, dispersibility of the rubber particles may be low, resulting in deterioration in overall quality.

The epoxy resin in step (d) may include the bisphenol-based resin described above, and an example thereof may include bisphenol A resin.

The rubber-modified epoxy resin may be an epoxy resin in which rubber particles are dispersed, or an epoxy resin in which rubber particles coated with an acrylic resin are dispersed.

The hardener may be related to thermal curing of the epoxy resin, may be in a solid and/or liquid state at room temperature, and may initiate polymerization reaction with epoxy while changing to a completely liquid state upon heating. The hardener may include an amine-based compound, an acid anhydride-based compound, a phenol-based compound, and the like, and an example thereof may include an aliphatic amine-based compound. The aliphatic amine-based compound may include any one selected from the group consisting of dicyandiamide, diethylenetriamine, triethylenetetramine, 3-diethylaminopropylamine, tetraethylenepentamine, and combinations thereof, and an example thereof may include dicyandiamide.

The flow regulator may be related to dischargeability, flowability, and filling of the composition. The flow regulator may include any one selected from the group consisting of calcium carbonate, carbon black, silica, alumina, titania, talc, mica, and combinations thereof, and an example thereof may include calcium carbonate.

The flow regulator may have a controlled particle size, and the particle size thereof may fall in the range of 5 μm to 30 μm, or 10 μm to 20 μm. Dischargeability may be more easily controlled in this particle size range.

The flow regulator may be surface-modified or coated with a fatty acid, and the fatty acid may be a C8-C20 fatty acid with an ester group (ion) and/or a carboxyl group. Examples of the fatty acid may include stearic acid, myristic acid, palmitic acid, and the like.

The storage stabilizer may be related to minimizing a change in viscosity of the composition when it is restored to room temperature after storage under conditions about 10-25° C. higher than room temperature (23° C.) and also to promoting curing. The storage stabilizer may include an aromatic amine-based compound, a urea-based compound, and the like, and an example thereof may include any one selected from the group consisting of imidazole, phenylimidazole, methylimidazole, 1-benzyl-2-methylimidazole, 4,4′-methylene bis phenyldimethyl urea, 3-(3,4-dichlorophenyl)-1,1-dimethylurea, 1,1-dimethyl-3-phenylurea, and combinations thereof. Preferably, the storage stabilizer includes a urea-based compound, 4,4′-methylene bis phenyldimethyl urea.

The epoxy adhesive composition may further include a moisture absorber, an adhesion enhancer, and a heat stabilizer.

The moisture absorber may be configured to remove moisture. The moisture absorber may include, for example, calcium oxide, magnesium oxide, calcium chloride, sodium hydroxide, and the like, and an example thereof may include calcium oxide.

The adhesion enhancer may be configured to enhance adhesion to steel and paint. The adhesion enhancer may include, for example, a silane-based compound, and examples thereof may include 3-aminopropyltriethoxysilane (APTES), N-(beta-aminoethyl)-gamma-aminopropyltrimethoxysilane (APTMS), (3-glycidoxypropyl) trimethoxysilane (GPTMS), vinyltriethoxysilane, 3-(methacryloxypropyl) trimethoxysilane (MPTMS), (3-chloropropyl) trimethoxysilane, 3-mercaptopropyltriethoxysilane, triethoxysilane, tetraethoxysilane, tetramethoxysilane, and the like.

The heat stabilizer may be related to heat resistance and may include tin oxide.

The epoxy adhesive composition may include, based on a total of 100 wt % thereof:
10 wt % to 25 wt % of the bisphenol-based epoxy resin,
41 wt % to 49 wt % of the rubber-modified epoxy resin,
7 wt % to 11 wt % of the hardener,
11 wt % to 20 wt % of the flow regulator,
5 wt % to 10 wt % of the moisture absorber,
3 wt % to 6 wt % of the adhesion enhancer,
0.8 wt % to 2.2 wt % of the heat stabilizer, and
0.5 wt % to 1.4 wt % of the storage stabilizer.

If the amount of the bisphenol-based epoxy resin is less than 10 wt %, shear bonding strength may deteriorate, whereas if it exceeds 25 wt %, dischargeability may decrease.

If the amount of the rubber-modified epoxy resin is less than 41 wt %, shear bonding strength and water washing resistance may deteriorate, whereas if it exceeds 49 wt %, dischargeability may decrease.

If the amount of the hardener is less than 7 wt %, shear bonding strength may deteriorate due to the uncured portion during curing, whereas if it exceeds 11 wt %, impact resistance may decrease.

If the amount of the flow regulator is less than 11 wt %, dischargeability, flowability, and workability may deteriorate, whereas if it exceeds 20 wt %, shear bonding strength and impact resistance may decrease.

If the amount of the moisture absorber is less than 5 wt %, swelling due to moisture may occur, whereas if it exceeds 10 wt %, adhesion may decrease.

If the amount of the adhesion enhancer is less than 3 wt %, adhesion to a steel plate may deteriorate, whereas if it exceeds 6 wt %, shear bonding strength may decrease.

If the amount of the heat stabilizer is less than 0.8 wt %, heat resistance may deteriorate, whereas if it exceeds 2.2 wt %, adhesion may decrease.

If the amount of the storage stabilizer is less than 0.5 wt %, storage stability may deteriorate, whereas if it exceeds 1.4 wt %, impact resistance may decrease.

In particular, the epoxy adhesive composition includes the rubber-modified epoxy resin, the flow regulator, and the storage stabilizer in specific amounts, thereby ensuring all of desired dischargeability, water washing resistance, storage stability, and shear bonding strength in various environments.

In addition, the epoxy adhesive composition may include, based on a total of 100 wt % thereof:
20 wt % to 25 wt % of the bisphenol-based epoxy resin,
42 wt % to 48 wt % of the rubber-modified epoxy resin,
8 wt % to 10 wt % of the hardener,
11 wt % to 19 wt % of the flow regulator,
5 wt % to 10 wt % of the moisture absorber,
3 wt % to 5 wt % of the adhesion enhancer,
1 wt % to 2 wt % of the heat stabilizer, and
0.6 wt % to 1.4 wt % of the storage stabilizer.

The epoxy adhesive composition may have a viscosity at 25° C. of 6,000,000 cP to 13,000,000 cP, or 7,000,000 cP to 12,000,000 cP. This viscosity range may contribute to obtaining water washing resistance.

The epoxy adhesive composition may have storage stability of 30% or less, as represented below:

$$( \vert c 1 - co \vert / co ) \times 100 \% [ Storage Stability ]$$

Here, c0 is the viscosity of the epoxy adhesive composition measured at a temperature of 23° C., and c1 is the viscosity of the epoxy adhesive composition measured at a temperature of 23° C. after exposure to a temperature of 45° C. for 168 hours.

Specifically, the epoxy adhesive composition may not show a great change in viscosity at 23° C. even when exposed to about 45° C., which is a working temperature, for a long period of time, and may maintain stable viscosity, dischargeability, and water washing resistance.

The epoxy adhesive composition may have a nozzle discharge time of 12 seconds to 30 seconds, 15 seconds to 25 seconds, or less than or equal to 20 seconds, as measured by the following method.

### [Nozzle Discharge Time]

A composition is placed in a dispenser having a nozzle diameter of 2.4 mm, and the time taken for 5 g of the composition to be discharged at a temperature of 40° C. under a discharge pressure of 40 bar is measured.

The epoxy adhesive composition has such a nozzle discharge time, thereby ensuring workability, productivity, and quality when applied to assembly processes, automation processes, etc.

The epoxy adhesive composition may have water washing resistance of 4 mm or less, 3 mm or less, or 2 mm or less, and 0.1 mm or more, as measured by the following method.

### [Water Washing Resistance]

A composition is applied to a length of 100 mm, a width of 18 mm, and a thickness of 6 mm onto a steel plate degreased with a solvent, water at 40° C. is sprayed at a pressure of 2 bar using a water sprayer having an inner diameter of 10 mm with a V-Fan nozzle at a location 30 mm away from the steel plate, in which spraying is performed for 1 minute at a speed of 1 time/sec under the condition that a reciprocating motion between both sides in the longitudinal direction of the applied composition is considered 1 time, and then a maximum width increase (mm) of the applied composition is measured.

The epoxy adhesive composition has such water washing resistance, thereby minimizing unnecessary contamination and preventing a decrease in shear bonding strength when applied to assembly processes, automation processes, etc.

The epoxy adhesive composition may have shear bonding strength of 25 MPa or more, or 28 MPa or more, and 45 MPa or less, as measured by the following method.

### [Shear Bonding Strength]

A composition is applied to a length of 12.5 mm, a width of a painted steel plate, and a thickness of 6 mm from one end toward the other end of the painted steel plate having an area of 100 mm×25 mm and a thickness of 0.8 mm, an identical painted steel plate is stacked thereon to overlap only the applied portion, followed by curing at a temperature of 180° C. for 20 minutes and leaving at a temperature of 23° C. for 1 hour, and then maximum strength is measured by pulling the ends of the painted steel plates opposite the applied portion at a speed of 5 mm/min using a tensile tester.

The epoxy adhesive composition has such shear bonding strength, thereby stably bonding a heavy part even when the bonding (stacking) direction is different from the direction of gravity.

The epoxy adhesive composition may be prepared by mixing the components described above and may not include a separate solvent.

### Epoxy Adhesive Structure

An epoxy adhesive structure according to an embodiment of the present disclosure includes a first member, a second member, and an adhesive interposed between the first member and the second member.

The adhesive may include an article obtained by curing the epoxy adhesive composition described above.

Each of the first and second members may be a steel plate, a painted member, a plastic member, a ceramic member, etc., and any member capable of epoxy bonding may be used without limitation.

At least one of the first member or the second member may comprise a vehicle structure.

Curing of the adhesive may be performed under curing conditions of a typical one-component epoxy adhesive, and for example, may be performed at a temperature of 130° C. to 190° C. for 10 to 200 minutes. Also, the adhesive may be left at room temperature (C) for 1 hour or more after curing.

A better understanding of the present disclosure may be obtained through the following examples and comparative examples. However, these examples are not to be construed as limiting the technical spirit of the present disclosure.

### Preparation Example—Rubber-Modified Epoxy Resin

A rubber-modified epoxy resin used in the following examples was prepared as follows.
(a) Butadiene rubber particles were added to an acrylic resin coating agent and stirred for 1.5 hours. As such, the acrylic resin coating agent included 35 wt % of an acrylic resin and the remainder of 2-butoxyethanol (Butyl CELLOSOLVE) as a solvent.
(b) The stirred result was cured at a temperature of 135° C. for 25 minutes.
(c) The cured result was ball-milled such that the particle size thereof was controlled to 120 μm or less.
(d) 65 wt % of the acrylic resin-coated butadiene particles, the particle size of which was controlled, and 35 wt % of bisphenol A epoxy resin were mixed, thereby obtaining an acrylic resin-coated butadiene-modified epoxy resin.

### Measurement Example—Viscosity, Dischargeability, Water Washing Resistance, Storage Stability, and Shear Bonding Strength

The properties of the obtained composition were measured by the following methods;

### (1) Viscosity

Measurement was performed with stirring at 2 rpm using a rotational viscometer (SP-7, IKA).

### (2) Dischargeability

The composition was placed in a dispenser having a nozzle diameter of 2.4 mm, and the time taken for 5 g of the composition to be discharged at a temperature of 40° C. under a discharge pressure of 40 bar was measured.

### (3) Water Washing Resistance

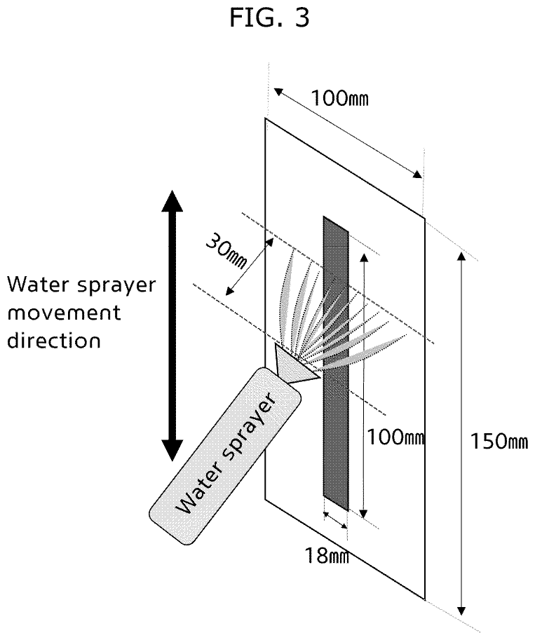

The composition was applied to a length of 100 mm, a width of 18 mm, and a thickness of 6 mm onto a steel plate (cold-rolled steel plate, SPRC340, POSCO) having an area of 150×100 mm² and a thickness of 0.8 mm degreased with a solvent, and as shown in FIG. 3, water at 40° C. was sprayed at an angle of 25 degrees and a pressure of 2 bar using a water sprayer having an inner diameter of 10 mm with a V-Fan nozzle at a location 30 mm away from the steel plate, in which spraying was performed for 1 minute at a speed of 1 time/sec under the condition that a reciprocating motion (100 mm×2) between both sides in the longitudinal direction of the applied composition is considered 1 time, after which a maximum width increase (mm) of the applied composition was measured.

### (4) Storage Stability (45° C., 40° C.)

The results of the following equation were obtained using the rotational viscometer.

(|c1−c0|/c0)×100%

Here, c0 is the viscosity of the epoxy adhesive composition measured at a temperature of 23° C., and c1 is the viscosity of the epoxy adhesive composition measured at a temperature of 23° C. after exposure to a temperature of 45° C. (or 40° C.) for 168 hours.

### (5) Shear Bonding Strength

The composition was applied to a length of 12.5 mm, a width of a painted steel plate, and a thickness of 6 mm from one end toward the other end of the painted steel plate having an area of 100 mm×25 mm area and a thickness of 0.8 mm, an identical painted steel plate was stacked thereon to overlap only the applied portion, followed by curing at a temperature of 180° C. for 20 minutes and leaving at a temperature of 23° C. for 1 hour, and then maximum strength was measured by pulling the ends of the painted steel plates opposite the applied portion at a speed of 5 mm/min using a tensile tester. Also, shear bonding strength was measured under the following conditions.
(5.1) Water resistance conditions: After curing, immersion in water at 40° C. for 168 hours followed by leaving at 23° C. for 1 hour
(5.2) Heat aging conditions: After curing, treatment at a temperature of 80° C. for 336 hours followed by leaving at 23° C. for 1 hour
(5.3) Heating repetition conditions: After curing, the following harsh conditions are repeated 5 times.

Harsh conditions: Treatment at 80° C. for 3 hours, leaving at 23° C. for 1 hour, treatment at −30° C. for 3 hours, leaving at 23° C. for 1 hour, treatment at 50° C. and 95% relative humidity for 15 hours, and leaving at 23° C. for 1 hour.

### (6) Impact Strength

A test specimen was prepared by applying and bonding the composition according to the ISO 11343 wedge impact method, and an impact peeling test was performed. The curing conditions of the composition were the same as in (5) above.

### Comparative Examples 1 to 6

Respective compositions were prepared by mixing, based on the total weight of the composition, 9 wt % of dicyandiamide as a hardener, 5 wt % of stearic acid-coated calcium carbonate as a flow regulator, 8 wt % of calcium oxide as a moisture absorber, 4 wt % of (3-glycidoxypropyl) trimethoxysilane (GPTMS) as an adhesion enhancer, 1.5 wt % of tin oxide as a heat stabilizer, and 1 wt % of 4,4′-methylene bis phenyldimethyl urea as a storage stabilizer, and also mixing the rubber-modified epoxy resin (Preparation Example) in the amount (wt %) shown in Table 1 below with the remainder of bisphenol A epoxy resin, after which some properties were evaluated.

TABLE 1

| | Comparative | Comparative | Comparative | Comparative | Comparative | Comparative |
|---|---|---|---|---|---|---|
| Classification | Example 1 | Example 2 | Example 3 | Example 4 | Example 5 | Example 6 |
| Weight of rubber- | 30% | 35% | 40% | 45% | 50% | 55% |
| modified epoxy | | | | | | |
| Viscosity (cP) | 4 million | 5.2 million | 7.5 million | 9.2 million | 12 million | 14 million |
| Dischargeability | 13 | 18 | 27 | 35 | 43 | 55 |
| (sec) | | | | | | |
| Water washing | 13 | 10 | 6 | 2 | 0 | 0 |
| resistance (mm) | | | | | | |

Referring thereto, in Comparative Examples 1 to 6, in which the weight of the flow regulator was insufficient, workability (viscosity, dischargeability, and water washing resistance) was not satisfied.

### Comparative Example 7, Examples 1 and 2, and Comparative Example 8

Respective compositions were prepared by changing the weight of the flow regulator in Comparative Example 4 as shown in Table 2 below, and then some properties were evaluated.

TABLE 2

| | Comparative | | | Comparative |
|---|---|---|---|---|
| Classification | Example 7 | Example 1 | Example 2 | Example 8 |
| Weight of flow regulator | 10% | 15% | 20% | 25% |
| Viscosity | 8.5 million | 8.2 million | 7.8 million | 7 million |
| (cP) | | | | |
| Dischargeability | 31 | 25 | 23 | 20 |
| (sec) | | | | |
| Water washing resistance | 2 | 1 | 2 | 3 |
| (mm) | | | | |

Referring thereto, Examples 1 and 2 satisfied the properties related to workability (viscosity, dischargeability, and water washing resistance), Comparative Example 7 had slightly insufficient dischargeability, and Comparative Example 8 had slightly decreased shear bonding strength and impact strength.

### Comparative Example 9, Example 1, Reference Example 1, and Comparative Example 10

Respective compositions were prepared by changing the weight of the storage stabilizer in Example 1 as shown in Table 3 below, and then some properties were evaluated.

TABLE 3

| | Comparative | | Reference | Comparative |
|---|---|---|---|---|
| Classification | Example 9 | Example 1 | Example 1 | Example 10 |
| Weight of storage | 0.5% | 1% | 1.5% | 2% |
| stabilizer | | | | |
| Storage stability | 23% | 20% | 18% | 17% |
| (40° C.) | | | | |
| Storage stability | 35% | 28% | 25% | 20% |
| (45° C.) | | | | |
| Shear bonding | 32 | 31 | 30 | 30 |
| strength | | | | |
| (MPa) | | | | |
| Impact strength | 39 | 37 | 34 | 32 |
| (N/mm) | | | | |

Referring thereto, Comparative Example 9 had deteriorated storage stability at 45° C., Reference Example 1 had slightly less than appropriate impact strength (35 N/mm), and Comparative Example 10 had decreased impact strength.

### Evaluation Results

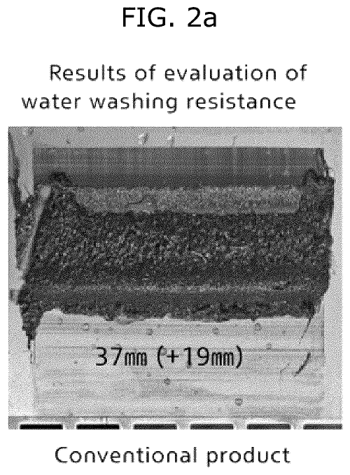

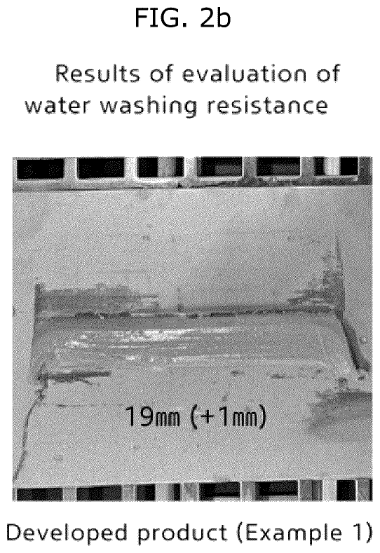

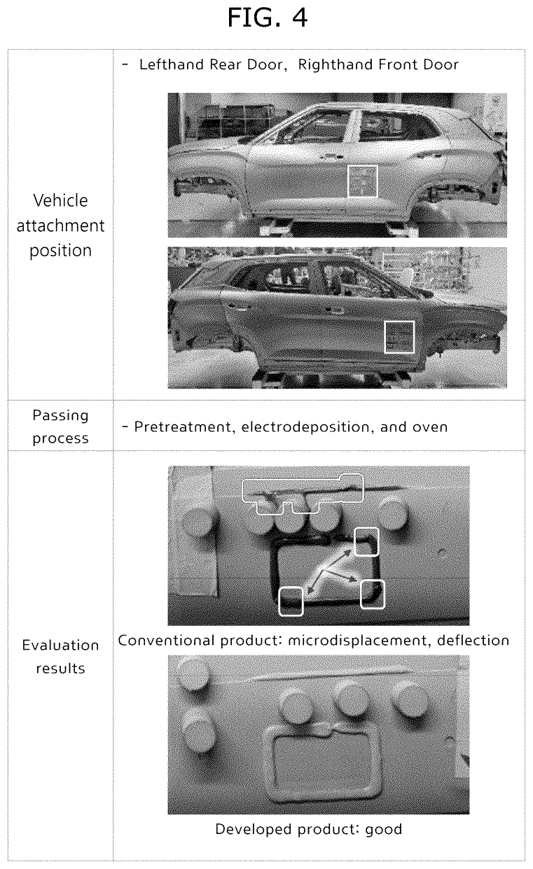

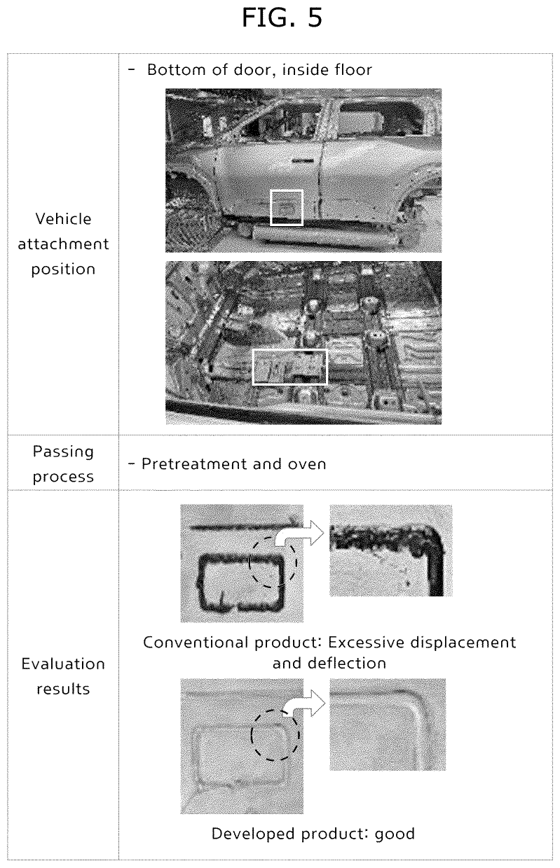

In addition, required properties of some other examples satisfying the appropriate weight ratio of the components of the composition were evaluated, and the results thereof are shown in Table 4 below and FIGS. 2A-2B, 4, and 5.

TABLE 4

| | | | | | Evaluation | |
|---|---|---|---|---|---|---|
| Classification | Conventional | | Desired values | | results | |
| 23° C. viscosity (cP) | 1.5 | million | 9 million + 3 | | 11.5 | million |
| | | | million | | | |
| 40° C. viscosity (cP) | — | | 3 million + 1 | | 4.1 | million |
| | | | million | | | |
| Dischargeability | — | | 30 | sec or less | 18 | sec |
| Water washing resistance | — | | 4 | mm or less | 1 | mm |
| Storage stability | 30% or less | | 30% or less | | 25% | |
| Shear bonding strength | 25 | MPa or more | 25 | MPa or more | 31 | MPa |
| Shear bonding strength (water | 25 | MPa or more | 25 | MPa or more | 27 | MPa |
| resistance) | | | | | | |
| Shear bonding strength (heat aging) | 25 | MPa or more | 25 | MPa or more | 29 | MPa |
| Shear bonding strength (heating | 25 | MPa or more | 25 | MPa or more | 32 | MPa |
| repetition) | | | | | | |

Referring thereto, it was confirmed that the developed product (Example), in which the components satisfied an appropriate weight ratio, compared to the conventional product without a high-viscosity epoxy and a flow inhibitor, exhibited vastly superior water washing resistance and good adhesion without displacement or deflection of the composition.

As is apparent from the foregoing, an epoxy adhesive composition according to the present disclosure can exhibit good dischargeability, water washing resistance, storage stability, and impact strength, and excellent shear bonding strength even in environments having high humidity, high temperature, etc.

In addition, the epoxy adhesive composition according to the present disclosure is capable of ensuring watertightness, and when applied to the bonding of a non-electrodeposited metal part and another metal part, quantitative and precise application of the epoxy adhesive composition becomes possible, thereby minimizing the contact area between different metals and preventing galvanic corrosion.

The effects of the present disclosure are not limited to the foregoing. It should be understood that the effects of the present disclosure include all effects that can be inferred from the description of the present disclosure.

Although specific embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. An epoxy adhesive composition comprising:
a bisphenol-based epoxy resin;
a rubber-modified epoxy resin;
a hardner;
a flow regulator; and
a storage stabilizer,
wherein the epoxy adhesive composition comprises 41 wt % to 49 wt % of the rubber-modified epoxy resin, 11 wt % to 20 wt % of the flow regulator, and 0.5 wt % to 1.4 wt % of the storage stabilizer based on a total of 100 wt % of the composition.

2. The epoxy adhesive composition of claim 1, wherein the rubber-modified epoxy resin comprises a rubber selected from the group consisting of butadiene rubber, acrylonitrile-butadiene rubber, styrene-butadiene rubber, and combinations thereof.

3. The epoxy adhesive composition of claim 1, wherein the rubber-modified epoxy resin is obtained by mixing a rubber component and a bisphenol A resin.

4. The epoxy adhesive composition of claim 3, wherein the rubber component is coated with an acrylic resin.

5. The epoxy adhesive composition of claim 1, wherein the hardener comprises an aliphatic amine-based compound, and the aliphatic amine-based compound is selected from the group consisting of dicyandiamide, diethylenetriamine, triethylenetetramine, 3-diethylaminopropylamine, tetraethylenepentamine, and combinations thereof.

6. The epoxy adhesive composition of claim 1, wherein the flow regulator is selected from the group consisting of calcium carbonate, carbon black, silica, alumina, titania, talc, mica, and combinations thereof.

7. The epoxy adhesive composition of claim 1, wherein the flow regulator is surface-modified or coated with a fatty acid.

8. The epoxy adhesive composition of claim 1, wherein the storage stabilizer is selected from the group consisting of imidazole, phenylimidazole, methylimidazole, 1-benzyl-2-methylimidazole, 4,4′-methylene bis phenyldimethyl urea, 3-(3,4-dichlorophenyl)-1,1-dimethylurea, 1,1-dimethyl-3-phenylurea, and combinations thereof.

9. The epoxy adhesive composition of claim 1, further comprising:
a moisture absorber;
an adhesion enhancer; and
a heat stabilizer.

10. The epoxy adhesive composition of claim 9, wherein the epoxy adhesive comprises 5 wt % to 10 wt % of the moisture absorber, 3 wt % to 6 wt % of the adhesion enhancer, and 0.8 wt % to 2.2 wt % of the heat stabilizer based on a total of 100 wt % of the composition.

11. The epoxy adhesive composition of claim 1, wherein the epoxy adhesive comprises 10 wt % to 25 wt % of the bisphenol-based epoxy resin and 7 wt % to 11 wt % of a hardener based on a total of 100 wt % of the composition.

12. The epoxy adhesive composition of claim 1, wherein the epoxy adhesive has a viscosity at a temperature of 25° C. of 6,000,000 cP to 13,000,000 cP and at a storage stability of 30% or less as represented below:
(|c1−c0|/c0)×100%
wherein c0 is the viscosity of the epoxy adhesive composition measured at a temperature of 23° C., and c1 is the viscosity of the epoxy adhesive composition measured at a temperature of 23° C. after exposure to a temperature of 45° C. for 168 hours.

13. The epoxy adhesive composition of claim 1, having water washing resistance of 4 mm or less, as measured by a following method:
[Water Washing Resistance]
A composition is applied to a length of 100 mm, a width of 18 mm, and a thickness of 6 mm onto a steel plate degreased with a solvent, water at 40° C. is sprayed at a pressure of 2 bar using a water sprayer having an inner diameter of 10 mm with a V-Fan nozzle at a location 30 mm away from the steel plate, in which spraying is performed for 1 minute at a speed of 1 time/sec under condition that a reciprocating motion between both sides in a longitudinal direction of the applied composition is considered 1 time, and then a maximum width increase (mm) of the applied composition is measured.

14. An epoxy adhesive structure comprising:
a first member;
a second member; and
an adhesive interposed between the first member and the second member,
wherein the adhesive comprises an article obtained by curing the epoxy adhesive composition of claim 1.

15. A method for preparing an epoxy adhesive composition, the method comprising:
mixing a bisphenol-based epoxy resin, a rubber-modified epoxy resin, a hardner, a flow regulator, and a storage stabilizer,
wherein mixing provides the epoxy adhesive composition comprising 41 wt % to 49 wt % of the rubber-modified epoxy resin, 11 wt % to 20 wt % of the flow regulator, and 0.5 wt % to 1.4 wt % of the storage stabilizer based on a total of 100 wt % of the composition.

16. The method of claim 15, further comprising preparing the rubber-modified epoxy resin by:
adding rubber particles to an acrylic resin coating agent and performing stirring;
curing a stirred result at a temperature;
controlling an average particle size of the cured result; and
mixing a particle size-controlled result with an epoxy resin.

17. The method of claim 16, wherein the rubber particles comprise a rubber selected from the group consisting of butadiene rubber, acrylonitrile-butadiene rubber, styrene-butadiene rubber, and combinations thereof.

18. The method of claim 16, wherein and the acrylic resin coating agent comprises 20 wt % to 50 wt % of an acrylic resin and 50 wt % to 80 wt % of a solvent.

19. The method of claim 16, wherein the solvent comprises an C1-C10 alcohol compound containing an ether group.

20. A method comprising:
applying an epoxy adhesive composition between an automotive structure and a member, wherein the epoxy adhesive composition comprises a bisphenol-based epoxy resin, a rubber-modified epoxy resin, a hardener, a flow regulator and a storage stabilizer, and wherein the epoxy adhesive composition comprises 41 wt % to 49 wt % of the rubber-modified epoxy resin, 11 wt % to 20 wt % of the flow regulator, and 0.5 wt % to 1.4 wt % of the storage stabilizer based on a total of 100 wt % of the composition;
curing the epoxy adhesive composition at a temperature of 130° C. to 190° C.; and
maintaining the cured composition at room temperature for at least 1 hour.
